(19) United States
(12) Patent Application Publication
(10) Pub. No.: US 2006/0059481 A1
(43) Pub. Date: Mar. 16, 2006

(54) Presenting, delivering and installing electronic downloads with an installed list

(76) Inventors: Rodney Smith, Issaquah, WA (US); Alan R. Johnson, Bothell, WA (US); Murugappan Palaniappan, Issaquah, WA (US); MeMe Rasmussen, San Carlos, CA (US); Douglas K. Brotz, Portland, OR (US)

Correspondence Address: FISH & RICHARDSON P.C., P.O. Box 1022, MINNEAPOLIS, MN, 55440-1022, US

(21) Appl. No.: 10/943,320

(22) Filed: Sep. 16, 2004

(51) Int. Cl. G06F 9/44

(52) U.S. Cl. 717/173

(57) ABSTRACT

Systems and methods for downloading and updating software, in which a plurality of manifest files are obtained, each manifest file containing information corresponding to one or more components. Information contained in each manifest file is displayed in a dual-list format, where a first list displays a component name for each component listed in each manifest file, including components installed and not installed on the computer, a second list displays the component name for each component of the first list that is installed on the computer, and the component names in the first list are displayed aligned with the component names in the second list such that the component name of each installed component that appears in the first list is displayed aligned with the component name of the same installed component on the second list.

### BACKGROUND

The present invention relates to downloading and updating software.

Software applications are used to perform specific tasks on a computer. Typically, before a user can use a software application on a specific computer, the software must be installed onto the computer. Although at the time of installation, the software might be the most current version available, software vendors frequently release updates and corrections to specific software applications. These updates might improve performance, correct errors, or add enhanced capabilities to the software application. The updates might be available on the Internet, or on fixed media such as a floppy disk, CD-ROM, or DVD.

Typically, in order to simplify the process of applying updates and corrections to software applications already installed, some sort of update application is also included with the software. However, these update applications are frequently limited to only being able to update the software application that the update application is associated with. Further, update applications generally display only the updates that have not yet been installed. A typical user has no way of knowing about the update components that have previously been installed. In addition, update applications generally only permit the installation of new updates not previously installed, and have no capability for the reinstallation of previously installed updates.

### SUMMARY

In general, in one aspect, the invention features a computer program product, tangibly embodied in an information carrier. The computer program product can include instructions operable to cause a computer to obtain a plurality of manifest files, each manifest file containing information corresponding to one or more components. The computer program product can also include instructions operable to cause a computer to display information contained in each manifest file in a dual-list format, where a first list displays a component name for each component listed in each manifest file, including components installed and not installed on the computer, a second list displays the component name for each component of the first list that is installed on the computer, and the component names in the first list are displayed aligned with the component names in the second list such that the component name of each installed component that appears in the first list is displayed aligned with the component name of the same installed component on the second list.

Advantageous implementations include one or more of the following features. Each manifest file may be associated with an installed product on the computer. Each manifest file may be associated with marketing materials available for download. The marketing materials may include marketing announcements, new products, free products, or trial products. The computer program product may include instructions operable to cause a computer to identify the installed products on the computer from a single file located on the user computer. The single file may be a settings file. The computer program product may also include instructions operable to cause a computer to identify each installed component on the computer from a keyfile associated with each installed component. The first list and the second list may be displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product. The component names associated with each installed product may be displayed in alphabetical, date of creation, or subject order. Each manifest file may contain version information for each individual component. The computer program product may also include instructions to compare version information extracted from each installed product with version information contained in the manifest file. The manifest file may contain the following information for each individual component: a name for the component, a short description of the component, a relative path pointing to a local file showing the component version on the client computer, any dependencies that must be present before the component file can be installed, and a pointer to the location of the component file. The pointer may be in the form of an uniform resource locator or a web service call. The short description of the component may be displayed to the user.

In another aspect, the invention features a computer program product, tangibly embodied in an information carrier. The computer program product can include instructions operable to cause a computer to identify one or more installed products on the computer. The computer program product can also include instructions operable to cause a computer to obtain one or more manifest files, where each manifest file is associated with one installed product and each manifest file contains information relating to one or more components of the corresponding installed product. The computer program product can further include instructions operable to cause a computer to display information contained in each manifest file in a dual-list format, where a first list displays a component name for each component listed in each manifest file, including components installed and not installed on the computer, a second list displays the component name for each component of the first list that is installed on the computer, and the component names in the first list are displayed aligned with the component names in the second list such that the component name of each installed component that appears in the first list is displayed aligned with the component name of the same installed component on the second list.

Advantageous implementations include one or more of the following features. Each manifest file obtained may be selected from a plurality of available manifest files. The computer program product may include instructions operable to cause a computer to identify each installed component on the computer from a keyfile associated with each installed component. The first list and the second list may be displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product. The component names associated with each installed product may be displayed in alphabetical, date of creation, or subject order. Each manifest file may contain the following information for each individual component: a name for the component, a short description of the component, a relative path pointing to a local file showing the component version on the client computer, any dependencies that must be present before the component file can be installed, and a pointer to the location of the component file. The pointer may be in the form of an uniform resource locator or a web service call. The short description of the component may be displayed to the user.

In another aspect, the invention features a computer program product, tangibly embodied in an information carrier. The computer program product can include instructions operable to cause a computer to receive a first list of available update components. The computer program product can also include instructions operable to cause a computer to display the first list of available update components. The computer program product can also include instructions operable to cause a computer to create a second list of installed update components by identifying one or more target files, where each update component is associated with a single target file. The computer program product can further include instructions operable to cause a computer to display the second list of installed update components, where the second list of installed update components is displayed adjacent to the first list of available update components, such that each item in the list of available update components is aligned with either the identical item in the second list of installed update components, if the component is installed, or a special placeholder, if the component is not installed.

Further, the computer program product can include instructions operable to cause a computer to enable the user to select one or more update components from the list of available update components, where the user may select from update components not installed as well as update components already installed. The computer program product can also include instructions operable to cause a computer to receive one or more selected update components. The computer program product can include instructions operable to cause a computer to install one or more selected update components.

Advantageous implementations include one or more of the following features. The list of available updates may be generated as each new update is published. The special placeholder may be a blank space, an icon, or a text message to the user. The special placeholder may be displayed in a color different from that used for installed update components. The special placeholder may be displayed in a font different from that used for installed update components.

In another aspect, the invention features a computer implemented method, which can include instructions operable to cause a computer to obtain a plurality of manifest files, each manifest file containing information corresponding to one or more components. The method also includes instructions operable to cause a computer to display information contained in each manifest file in a dual-list format, where a first list displays a component name for each component listed in each manifest file, including components installed and not installed on the computer, a second list displays the component name for each component of the first list that is installed on the computer, and the component names in the first list are displayed aligned with the component names in the second list such that the component name of each installed component that appears in the first list is displayed aligned with the component name of the same installed component on the second list.

Advantageous implementations include one or more of the following features. Each manifest file may be associated with an installed product on the computer. One or more manifest files may be associated with marketing materials available for download. The marketing materials may include marketing announcements, new products, free products, or trial products.

In another aspect, the invention features a computer implemented method, which can include identifying one or more installed products on the computer. The method can also include obtaining one or more manifest files, where each manifest file is associated with one installed product and each manifest file contains information relating to one or more components of the corresponding installed product. Moreover, the method can include displaying information contained in each manifest file in a dual-list format, where a first list displays a component name for each component listed in each manifest file, including components installed and not installed on the computer, a second list displays the component name for each component of the first list that is installed on the computer, and the component names in the first list are displayed aligned with the component names in the second list such that the component name of each installed component that appears in the first list is displayed aligned with the component name of the same installed component on the second list.

Advantageous implementations include one or more of the following features. The first list and the second list may be displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product.

In another aspect, the invention features a computer implemented method, which can include receiving a first list of available update components. The method also includes displaying the first list of available update components. The method further includes creating a second list of installed update components by identifying one or more target files, where each update component is associated with a single target file. Moreover, the method includes displaying the second list of installed update components, where the second list of installed update components is displayed adjacent to the first list of available update components, such that each item in the list of available update components is aligned with either the identical item in the second list of installed update components, if the component is installed, or a special placeholder, if the component is not installed.

Further, the method includes having the user select one or more update components from the list of available update components, where the user may select from update components not installed as well as update components already installed. The method includes receiving one or more selected update components. The method also includes installing one or more selected update components.

The invention can be implemented to realize one or more of the following advantages. A list of available updates will be displayed in conjunction with a list of installed updates, allowing a computer user to readily see which update components have already been installed, and which update components have yet to be installed. A computer user will be able to select any available component to be installed, whether or not it has been installed previously. A list of already installed updates will be generated automatically, so that no listing of installed updates need be maintained on the user's computer.

Further, low network bandwidth is required, as little administrative data must be transferred to and from the user's computer. Privacy and security concerns are also addressed, as no information about the user's computer need be sent to anyone else, except for the identity of the software applications that the user is attempting to update for the purpose of retrieving the list of updates associated with that software application.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a flow chart of a method for identifying available and installed components on a computer.

FIG. 2 is a flow chart of a method for displaying available and installed components.

FIG. 3 shows a user interface displaying available and installed components.

FIG. 4 shows a user interface displaying components ready to be installed.

Like reference numbers and designations in the various drawings indicate like elements.

### DETAILED DESCRIPTION

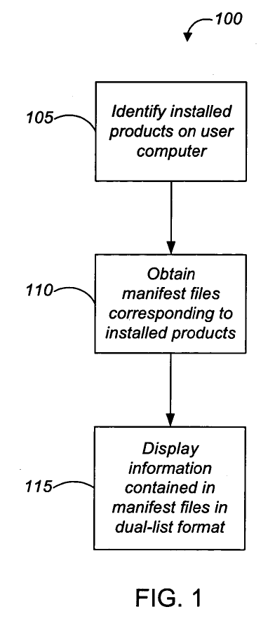

FIG. 1 shows a method 100 for identifying available and installed components on a computer. A system performing method 100 identifies installed products on a user computer (step 105). The installed products can be software applications, documentation, or other resources that require periodic updates. In one implementation, one or more installed products on the user computer are identified by means of a single file maintained on the user computer. The single file can be an Extensible Markup Language (XML) file. The single file is created or modified by the system when each installed product is originally installed, and provides the system with information necessary to identify each specific product; for instance, this information can include the product name, the product version, the product language, and the operating system language. The single file can also include information indicating where each specific product is installed on the user computer. In one implementation, this single file contains information on all installed products from one software provider; for example, the single file contains information on all Adobe® products installed on the user computer. In an alternative implementation, the system stores information on installed products from multiple providers. Each installed product passes an application identifier to the system, to identify the specific installed product on the user computer. The application identifier can be in a file that is affiliated with each installed product that uniquely identifies each installed product to the system.

The system obtains one or more manifest files corresponding to the installed products (step 10). The manifest file contains information about each update that is available for the corresponding installed product on the user computer. In one implementation, each product configuration has a unique manifest file that corresponds with that product. For example, a manifest file would exist that corresponds to Adobe® Acrobat® 6.0 U.S. English. A different manifest file would exist for Acrobat® 6.0 German, and a third manifest file would exist for Acrobat® 5.5 U.S. English. In one implementation, the system obtains the manifest file that is required from among all of the manifest files available. The manifest files can be obtained from a variety of sources. In one implementation, the system obtains the manifest files from a server over a data communication network, e.g., the Internet. In another implementation, the manifest files are obtained from removable media, e.g., a floppy disk, CD-ROM disk, or DVD disk.

The application identifier is used to identify a specific manifest file in a specified location, e.g., on a predetermined server. The system uses the application identifier to identify the installed products for which manifest files need to be obtained. Manifest files can then be obtained for the identified installed products. The manifest file contains the information that is used to determine the available updates for the installed product on the user computer. Initially, the manifest file contains no update information. As updates are generated, a new manifest file is created that contains information on the new updates, as well as any previous updates.

In one implementation, the manifest file is an XML file. The information to be included in the manifest file is included in the XML file in a standardized form recognizable as a manifest file. The XML manifest file can be made available on specified servers for download by a user computer.

The manifest files contain information detailing the updates that are available for each installed product. The manifest files do not contain the actual update components; rather, the manifest files contain information that corresponds to each available update component. For example, the manifest file can contain the following information for each update available: the name of the update; a short description of the update; a relative path that points to a local file on the user computer showing the current version of the component being updated; and instructions for obtaining the update.

The manifest file can also contain information identifying which method to use to extract version information from the local file, and how to compare the extracted version information with the version information associated with each update identified in the manifest file. In addition, the manifest file can include information concerning any dependencies that must be present before a particular update can be delivered and installed. For example, a specific update can require a newer or specific version of the updater itself. Alternatively, an update can require another update in order to be installed properly.

In one implementation, the system can handle manifest file containing all of these elements. In another implementation, the system can handle manifest files containing any combination of these elements, in any order, as well as additional elements not listed here.

The system displays information contained in the manifest file in a dual-list format (step 115). In one implementation, the dual-list display format presents two parallel lists. The first list displays details of all available update components for each installed product. This includes update components that have already been installed on the user computer, as well as update components not yet installed. This list can be ordered in any manner selected by the user; for example, the first list can be presented in alphabetical order, chronological order by date of the update components, or in a hierarchical manner, such that all update components associated with each installed product are grouped together.

The second list displays details of all of the update components that have already been installed on the user computer. In one implementation, information concerning updates already installed on the user computer is collected using key files. A key file is a designated file that is part of each installed update component. For example, consider an update component that installs one or more files on the user computer, all of which are essential for the proper functioning of the update component. One of these installed files can be designated as a key file. The presence of the key file indicates that the update component has been installed on the user computer. The key file can also provide information as to the specific version of the update component. In an alternative implementation, the system can refer to a single file maintained by the system that contains information concerning update components already installed for a plurality of installed products. This single file is modified every time a new update component is installed for any of the installed products referenced in the file. Alternatively, if the system is based on a Microsoft® Windows® operating system, the system can use entries in the registry database to maintain information about update components already installed.

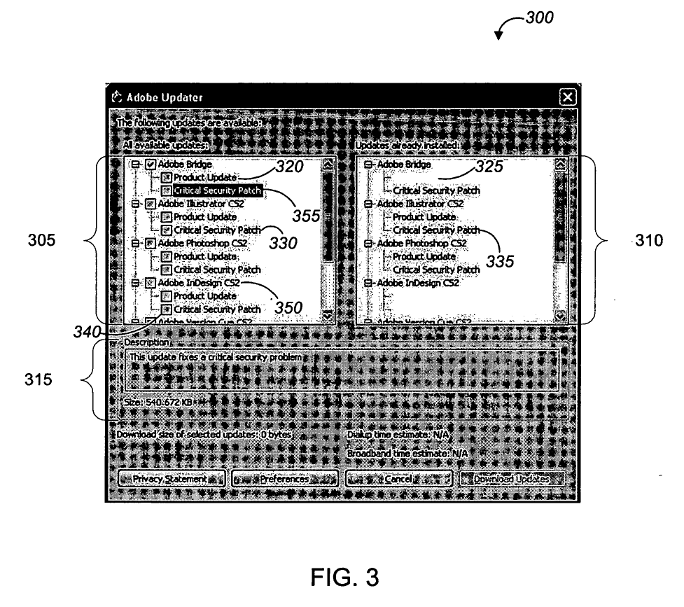

The second list is displayed in such a manner so that update components that appear in the second list appear in the same row as the same update component on the first list. FIG. 3 shows an example user interface 300, in which the available update component 330 in the first list of available update components 305 is displayed across from the same installed component 335 in the second list of installed update components 310. Further, if an available update component has not yet been installed, a blank space appears in the second list 310 in order to maintain the proper spacing and alignment of both lists. In FIG. 3, available update component 320 in the first list of available update components 305 is aligned with the blank space 325 in the second list of installed update components 310. The blank space 325 indicates that this update component has not yet been installed on the user computer. Rather than a blank space, an alternative placeholder can be used. This placeholder can be a brief message indicating that the component has not yet been installed or an icon having the same significance.

The short description 315 displayed is the short description that is contained in the manifest file for the selected update component 355. The two lists can be displayed in column format, such that the first list and the second list are displayed as two rows, with matching update components on both lists listed in the same column. Alternatively, the first list and the second list can be displayed in rows or in any other manner that retains the alignment between matching update components appearing on both lists.

The alignment between the first list and the second list is always maintained, even if the first list and the second list are too long to display completely in the space available, in which case, the user can scroll the contents of the first list and the second list to view the entire list. While scrolling, the first list and the second list will move together, so that the items in the first list will always remain in alignment with the same corresponding item in the second list.

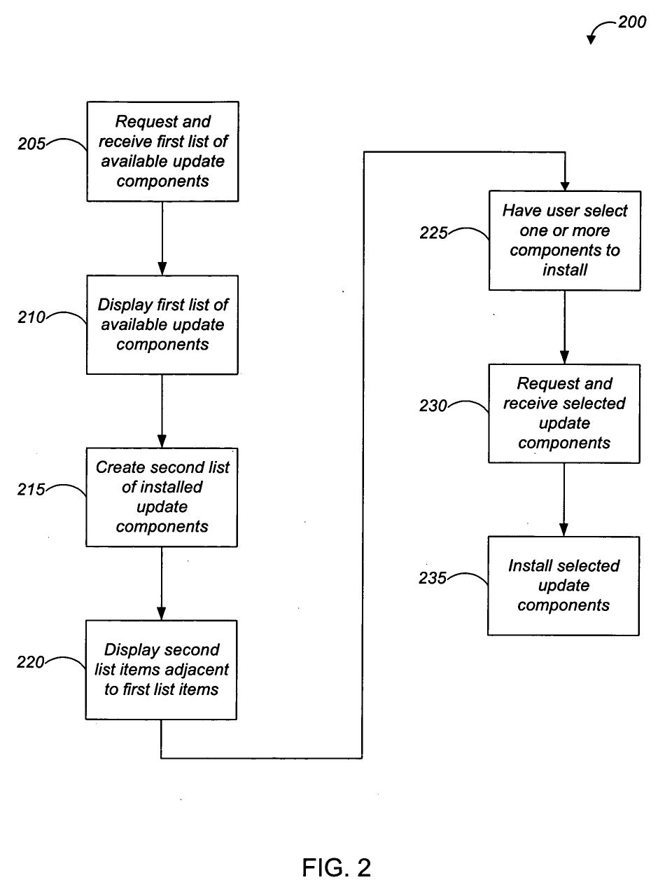

FIG. 2 shows a method 200 for installing selected update components. A system performing method 200 requests and receives a first list of available update components (step 205). This list can be requested from and received in a variety of forms; for example, the first list can be requested over a computer network, e.g., the Internet or a local area network (LAN), and can be received over the same computer network. Alternatively, the list can be received over a different computer network. The list can also be made available on removable media, e.g., a floppy disk, CD-ROM, or DVD.

In one implementation, the first list can also include information that is associated with the available update components. For example, the list can include the name of each available component and instructions on how to obtain each available component. The list can optionally include a brief description of each available component, or any other useful information.

The system displays the first list of available update components (step 210). The available components can be ordered and displayed in a variety of formats; some of the various formats available are described above. The preferred display format will typically be predefined by the update application, although the user also has the capability of selecting the desired display order. In another implementation, update component information in addition to or instead of the component name can also be displayed in the second list.

In FIG. 3, the list of available update components 305 is displayed in a hierarchical format. In this case, the name of each available update is displayed, with the available updates grouped together based upon the software application associated with each available update. The name of the software program 350 appears above the names of the available update components associated with the software program. Update components common to multiple programs can appear together in one common area, or can also appear with each of the respective products that each update component is associated with.

The system creates a second list of installed update components (step 215). The system determines what update components are already installed on the user's computer. This may be done in a variety of manners. In one implementation, the system can use the key file method as described above. In an alternative implementation, the system can refer to a single file that contains information relating to the update components already installed.

The system displays the items of the second list aligned with the items of the first list (step 220). The names of the installed update components are displayed in a similar format as the list of available update components. In one implementation, the order of the second list will be the same order as that of the first list, so that identical entries on each list are aligned. This can be seen in FIG. 3, where available update component 330 in the first list of available update components 305 is displayed across from the same installed component 335 in the second list. In the second list of installed update components 310, the names of the installed updates are listed in hierarchical format, to match the display order in the first list of available update components 305. In another implementation, update component information in addition to or instead of the component name can also be displayed in the second list.

In order for the second list to remain aligned with the first list, blank spaces appear when an available update that appears on the first list is not installed. In FIG. 3, blank space 325 indicates that the available “9.0.1 Update” component listed in the first list of available update components 305 is not installed. In addition to keeping the first list and the second list aligned, the blank space 325 also enables the user to easily determine what update components have not yet been installed. In an alternative embodiment, an alternative placeholder can be used, e.g., a brief message indicating that the component has not yet been installed.

The system allows the user to select one or more components to install (step 225). The user can select any available update components, including components that have already been installed, as well as components that have not yet been installed. A user may wish to select a previously installed component for a variety of reasons. For example, the component may have become corrupted or damaged. In one implementation, the user selects each desired update component by selecting a check box 340 adjacent to the name of the update component in the user interface 300.

The system requests and receives the selected update components (step 230). In one implementation, the location of each update component is indicated in the first list of available update components received (step 205). Update components can be requested and received from a variety of sources; for example, a request for the update component can be sent over a computer network, e.g., the Internet or a local area network (LAN), and the update component can be received over the same computer network. Alternatively, the update component can be received over a different computer network. The location of the update component can be provided by means of a uniform resource locator (URL) or by means of a web service call. Alternatively, the components can be made available by means of removable media, such as a floppy disk, CD-ROM, or DVD.

The system installs selected update components (step 235). In one implementation, this is performed automatically by the system. After the user selects the desired components in step 225, the system automatically installs the components without any further intervention by the user. In an alternative implementation, the user is prompted to install the components manually.

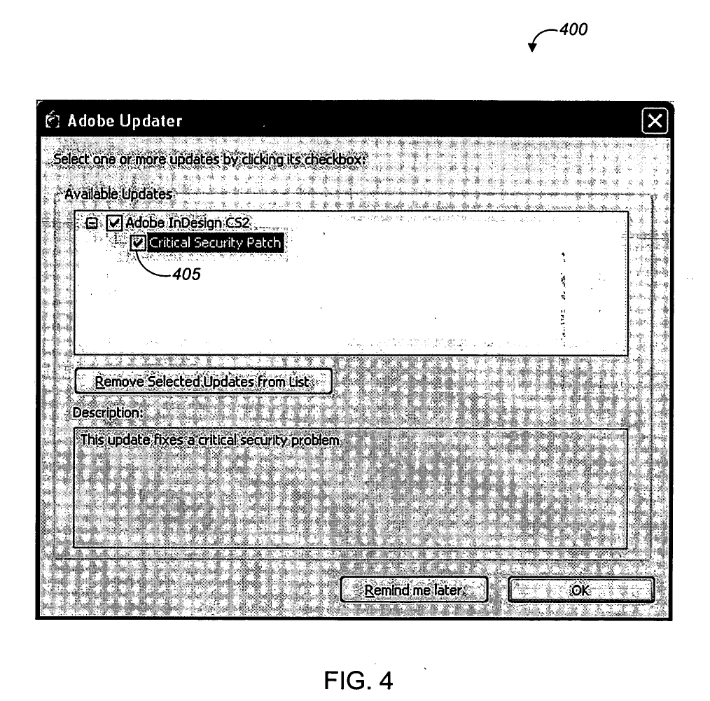

FIG. 4 shows an example user interface 400 displayed to the user when components are ready to be installed. The user can confirm the components to be installed by ensuring that the check box 405 is selected.

The system can operate as an automated system that checks for updates periodically, depending on the needs of the user. For example, a user might wish to have the invention check for updates on a weekly basis. In this case, at a specific time each week, the list of available update components would be received, and if any new update components are available, the user will be notified. Alternatively, if there are any update components available that are not installed on the user's computer, the user will be notified. The user can choose to complete the update process as described above. The invention can also be applied to itself. For example, the update software component can check to see if there are any update components for itself, and install them if desired. In another alternative, the user might wish to check for updates at a regular interval, e.g., once a month, upon starting one of the installed programs. In this instance, after starting one of the installed programs, if the requested time period between checking for updates has elapsed, a check for updates occurs. In this manner, a separately running program to check for updates is not required, requiring the use of fewer system resources, such as memory and CPU usage.

The user can also elect to search for update components at any time. In one implementation, the user can launch any program supported by the updater, and from within the software run the updating process. For example, in all Adobe® software applications that feature updates, a user can manually initiate an update request by selecting Updates from the Help drop-down menu.

The invention can also be implemented across a network of computers, so that update components can be installed from a remote location. For example, a network administrator can install update components on multiple computers from a single location. The network administrator can install update components on an as-needed basis for each computer on the network, or can have the invention check for new update components on a regular basis, for example, every day or every week. Any new updates can then be installed automatically on each computer on the network.

The invention can also be implemented to distribute a variety of components in addition to update components. These components can include marketing announcements, new products, free products, trial products, or other similar items, that the user can download if desired. In such an instance, the manifest file that is distributed contains information that is associated with the components being distributed. The user can then view the available components and the installed components in the dual-column display format discussed above, and can select any desired components for download and installation.

Further, the manifest files and update components can be kept on a local area network (LAN), for example on a server accessible from within the LAN. Client computers can request manifest files from the server on the LAN, instead of or in addition to requesting manifest files on the Internet or through some other means. In addition, the update components can also be available from the server. This implementation also has the added benefit of reducing Internet bandwidth requirements, as each computer on the LAN can access manifest files and update components locally.

The invention and all of the functional operations described in this specification can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. A variety of devices possess both a processor for executing instructions and one or more memory devices for storing instructions and data, e.g., desktop and notebook computers, portable media players, personal digital assistants (PDA), and cellular phones. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A computer program product, tangibly embodied in an information carrier, comprising instructions operable to cause a computer to:
obtain a plurality of manifest files, each manifest file containing information corresponding to one or more components; and
display information contained in each manifest file in a dual-list format, wherein: a first list displays a component name for each component listed in each manifest file, including components installed and not installed on the computer; a second list displays the component name for each component of the first list that is installed on the computer; and the component names in the first list are displayed aligned with the component names in the second list such that the component name of each installed component that appears in the first list is displayed aligned with the component name of the same installed component on the second list.

2. The computer program product of claim 1, wherein each manifest file is associated with an installed product on the computer.

3. The computer program product of claim 2, further comprising instructions to identify the installed products on the computer from a single file located on the user computer.

4. The computer program product of claim 3, wherein the single file is a settings file.

5. The computer program product of claim 1, further comprising instructions to identify each installed component on the computer from a keyfile associated with each installed component.

6. The computer program product of claim 1, wherein the first list and the second list are displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product.

7. The computer program product of claim 6, wherein the component names associated with each installed product are displayed in alphabetical, date of creation, or subject order.

8. The computer program product of claim 1, wherein each manifest file contains version information for each individual component.

9. The computer program product of claim 8, further comprising instructions to compare version information extracted from each installed product with version information contained in the manifest file.

10. The computer program product of claim 1, wherein the manifest file contains the following information for each individual component:
a name for the component;
a short description of the component;
a relative path pointing to a local file showing the component version on the client computer;
any dependencies that must be present before the component file can be installed; and
a pointer to the location of the component file.

11. The computer program product of claim 10, wherein the pointer is in the form of an uniform resource locator or a web service call.

12. The computer program product of claim 10, wherein the short description of the component is displayed to the user.

13. The computer program product of claim 1, wherein one or more manifest files are associated with marketing materials available for download.

14. The computer program product of claim 13, wherein the marketing materials include marketing announcements, new products, free products, or trial products.

15. A computer program product, tangibly embodied in an information carrier, comprising instructions operable to cause a computer to:
identify one or more installed products on the computer;
obtain one or more manifest files, wherein each manifest file is associated with one installed product and each manifest file contains information relating to one or more components of the corresponding installed product; and
display information contained in each manifest file in a dual-list format, wherein: a first list displays a component name for each component listed in each manifest file, including components installed and not installed on the computer; a second list displays the component name for each component of the first list that is installed on the computer; and the component names in the first list are displayed aligned with the component names in the second list such that the component name of each installed component that appears in the first list is displayed aligned with the component name of the same installed component on the second list.

16. The computer program product of claim 15, wherein each manifest file obtained is selected from a plurality of available manifest files.

17. The computer program product of claim 15, further comprising instructions to identify each installed component on the computer from a keyfile associated with each installed component.

18. The computer program product of claim 15, wherein the first list and the second list are displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product.

19. The computer program product of claim 18, wherein the component names associated with each installed product are displayed in alphabetical, date of creation, or subject order.

20. The computer program product of claim 15, wherein each manifest file contains the following information for each individual component:
a name for the component;
a short description of the component;
a relative path pointing to a local file showing the component version on the client computer;
any dependencies that must be present before the component file can be installed; and
a pointer to the location of the component file.

21. The computer program product of claim 20, wherein the pointer is in the form of an uniform resource locator or a web service call.

22. The computer program product of claim 20, wherein the short description of the component is displayed to the user.

23. A computer program product, tangibly embodied in an information carrier, comprising instructions operable to cause data processing apparatus to:
receive a first list of available update components;
display the first list of available update components;
create a second list of installed update components by identifying one or more target files, wherein each update component is associated with a single target file;
display the second list of installed update components, wherein the second list of installed update components is displayed adjacent to the first list of available update components, such that each item in the list of available update components is aligned with either the identical item in the second list of installed update components, if the component is installed, or a special placeholder, if the component is not installed;
enable the user to select one or more update components from the list of available update components, wherein the user may select from update components not installed as well as update components already installed;
receive one or more selected update components; and
install one or more selected update components.

24. The computer program product of claim 23, wherein the list of available updates is generated as each new update is published.

25. The computer program product of claim 23, wherein the special placeholder is a blank space, an icon, or a text message to the user.

26. The computer program product of claim 25, wherein the special placeholder is displayed in a color different from that used for installed update components.

27. The computer program product of claim 25, wherein the special placeholder is displayed in a font different from that used for installed update components.

28. A computer implemented method, comprising:
obtaining a plurality of manifest files, each manifest file containing information corresponding to one or more components; and
displaying information contained in each manifest file in a dual-list format, wherein: a first list displays a component name for each component listed in each manifest file, including components installed and not installed on the computer; a second list displays the component name for each component of the first list that is installed on the computer; and the component names in the first list are displayed aligned with the component names in the second list such that the component name of each installed component that appears in the first list is displayed aligned with the component name of the same installed component on the second list.

29. The method of claim 28, wherein each manifest file is associated with an installed product on the computer.

30. The method of claim 28, wherein one or more manifest files are associated with marketing materials available for download.

31. The method of claim 30, wherein the marketing materials include marketing announcements, new products, free products, or trial products.

32. The method of claim 28, wherein the first list and the second list are displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product.

33. A computer implemented method, comprising:
identifying one or more installed products on the computer;
obtaining one or more manifest files, wherein each manifest file is associated with one installed product and each manifest file contains information relating to one or more components of the corresponding installed product; and
displaying information contained in each manifest file in a dual-list format, wherein:
a first list displays a component name for each component listed in each manifest file, including components installed and not installed on the computer; a second list displays the component name for each component of the first list that is installed on the computer; and the component names in the first list are displayed aligned with the component names in the second list such that the component name of each installed component that appears in the first list is displayed aligned with the component name of the same installed component on the second list.

34. The method of claim 33, wherein the first list and the second list are displayed in a hierarchical structure in which component names identified with a first installed product are displayed together and that component names identified with a second installed product are displayed together, but the component names associated with both the first installed product and the second installed product are displayed together, separate from the component names associated solely with either the first or second installed products, and the component names associated with the first installed product are displayed separate from the component names associated with the second installed product.

35. A computer implemented method, comprising:
receiving a first list of available update components;
displaying the first list of available update components;
creating a second list of installed update components by identifying one or more target files, wherein each update component is associated with a single target file;
displaying the second list of installed update components, wherein the second list of installed update components is displayed adjacent to the first list of available update components, such that each item in the list of available update components is aligned with either the identical item in the second list of installed update components, if the component is installed, or a special placeholder, if the component is not installed;
having the user select one or more update components from the list of available update components, wherein the user may select from update components not installed as well as update components already installed;
receiving one or more selected update components; and
installing one or more selected update components.
